(19) United States
(12) Patent Application Publication
(10) Pub. No.: US 2024/0214120 A1
(43) Pub. Date: Jun. 27, 2024

(54) Ultra-High Reliability Millimeter Wave Physical Layer Range Extension

(71) Applicant: Ofinno, LLC, Reston, VA (US)

(72) Inventors: Leonardo Alisasis Lanante, Reston, VA (US); Jeongki Kim, Fairfax, VA (US); Serhat Erkucuk, Reston, VA (US)

(73) Assignee: Ofinno, LLC, Reston, VA (US)

(21) Appl. No.: 18/392,302

(22) Filed: Dec. 21, 2023

Related U.S. Application Data
(60) Provisional application No. 63/434,801, filed on Dec. 22, 2022.

(51) Int. Cl. H04L 1/08; H04L 1/00

(52) U.S. Cl. CPC H04L 1/08; H04L 1/0003

(57) ABSTRACT

A first station (STA) receives a first frame indicating a capability of a second STA to receive a first number of repetitions of a first signal field of a Physical Layer Protocol Data Unit (PPDU), where the first number of repetitions comprises more than two. The first STA encodes the PPDU such that the first signal field comprises up to the first number of repetitions based on the capability of the second STA. The first STA transmits, to the second STA, the PPDU, based on the encoding.

### CROSS-REFERENCE TO RELATED APPLICATIONS

This application claims the benefit of U.S. Provisional Application No. 63/434,801, filed Dec. 22, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates example Physical Layer Protocol Data Units (PPDUs) which may be used by a STA to transmit on a wireless medium using Enhanced Distributed Channel Access (EDCA).

FIG. 4 illustrates additional example PPDUs which may be used by a STA to transmit on a wireless medium using EDCA.

FIG. 5 illustrates an example High Efficiency (HE) Extended Range (ER) Single User (SU) PPDU.

FIG. 6 illustrates an example portion of an EHT PPDU including an EHT extended range preamble.

FIG. 7 illustrates examples of encoding of non-UHR portions of a mmWave PPDU.

FIG. 8 illustrates examples of encoding of UHR portions of a mmWave PPDU.

FIG. 9 illustrates additional examples of encoding of UHR portions of a mmWave PPDU.

FIG. 10 illustrates an example of flexible time domain repetition for a preamble according to aspects of the present disclosure.

FIG. 11 illustrates an example channel access operation using flexible frequency domain repetition techniques according to aspects of the present disclosure.

FIG. 12 illustrates an example channel access operation using flexible frequency domain repetition autodetection according to aspects of the present disclosure.

FIG. 13 illustrates an example channel access operation using fixed frequency domain repetition and flexible time domain repetition according to aspects of the present disclosure.

FIG. 14 illustrates an example channel access operation using flexible frequency domain repetition and flexible time domain repetition according to aspects of the present disclosure.

FIG. 15 illustrates an example channel access operation using capability exchange according to aspects of the present disclosure.

FIG. 16 illustrates an example channel access operation using repetition feedback according to aspects of the present disclosure.

FIG. 17 illustrates an example process according to aspects of the present disclosure.

FIG. 18 illustrates an example process according to aspects of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

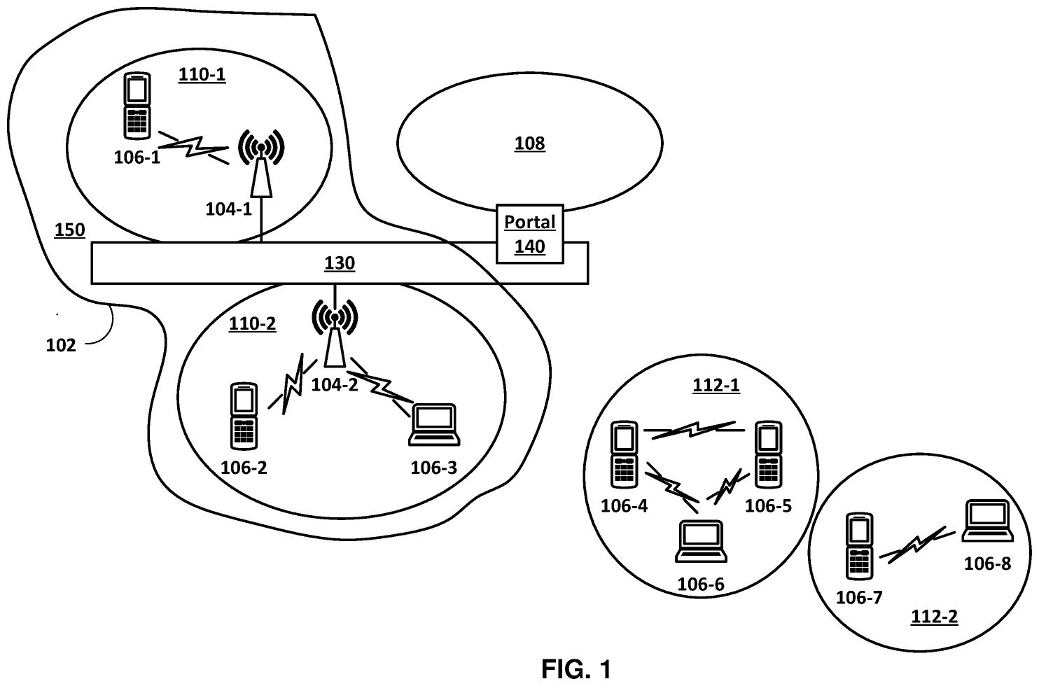

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs), such as BSS 110-1 and BSS 110-2 and a distribution system (DS) 130.

BSS 110-1 and BSS 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, AP 104-1 and AP 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STA 106-4, STA 106-5, and STA 106-6 may be configured to form a first IBSS 112-1. Similarly, STA 106-7 and STA 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY Convergence Protocol (PLCP) service data unit (PSDU). For example, the PSDU may include a PLCP preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 gigahertz (GHz), 5 GHZ, and/or 6 GHZ bands, each of which may be divided into multiple 20 megahertz (MHZ) channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHZ, 160 MHZ, or 320 MHz by bonding together multiple 20 MHz channels.

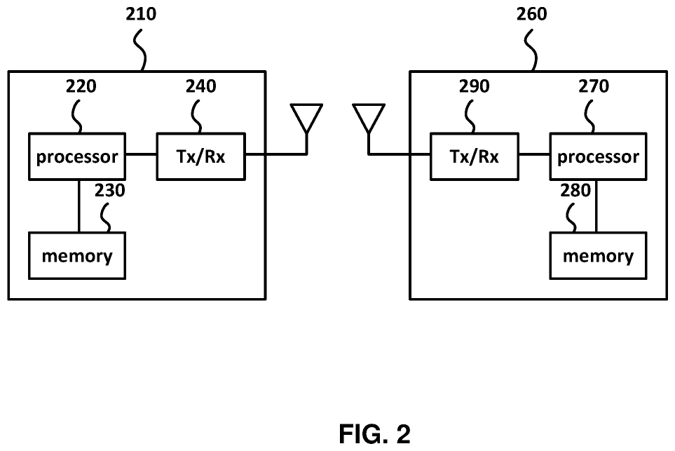

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

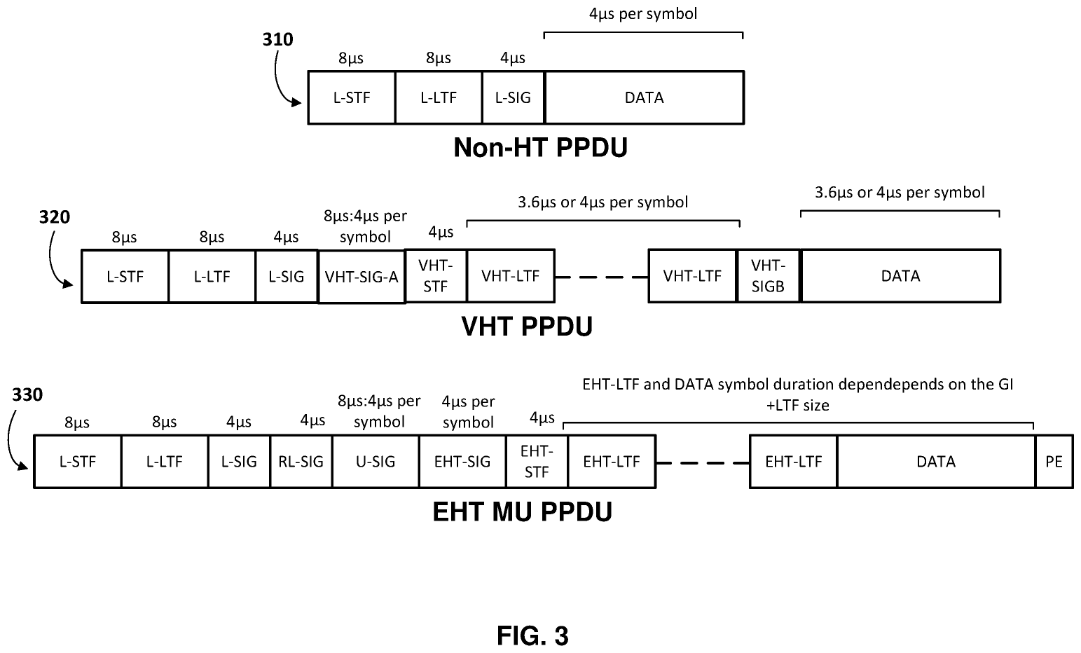

FIG. 3 illustrates examples of PPDUs which may be used by a STA to transmit on a wireless medium using Enhanced Distributed Channel Access (EDCA). Non-High Throughput (non-HT) PPDU 310 may be used by STAs conforming to the IEEE 802.11a standard amendment. Non-HT PPDU 310 has a preamble duration of 20 μs.

As shown in FIG. 3, Non-HT PPDU 310 includes a Non-HT Short Training field (L-STF), a Non-HT Long Training field (L-LTF), a Non-HT Signal field (L-SIG), and a Data field. Short training fields, such as the L-STF, are used by a receiver of the PPDU to synchronize with the carrier frequency and frame timing of a transmitter of the PPDU and to adjust the receiver signal gain. Long Training fields, such as the L-LTF, are used by the receiver of the PPDU to estimate channel coefficients in order to equalize the channel response (e.g., amplitude and phase distortion) in both Signal fields and Data fields of the PPDU.

Signal fields, such as the L-SIG, contain parameters needed to demodulate the Data field, which contains a payload of the PPDU. L-SIG may be equalized using the channel coefficients estimated using the L-LTF and demodulated to obtain the demodulation parameters of the Data field.

The Data Field of non-HT PPDU 310 includes one or more symbols each having a duration of 4 μs, where 3.2 μs carry symbol information and 0.8 μs carry a Guard Interval (GI). For Non-HT PPDUs, the only supported bandwidth is 20 MHz, which is divided into 64 subcarriers. This means that the PPDU is encoded with a subcarrier spacing of 20 MHz/64 or 312.5 kHz.

Very High Throughput (VHT) PPDU 320 may be used by STAs conforming to the IEEE 802.11ac standard amendment. VHT PPDU 320 can support MIMO to up to 8 spatial streams, which enhances spectral efficiency eight folds. VHT PPDU 320 has a minimum preamble duration of 39.6 μs, which may increase depending on the number of spatial streams carried by the PPDU.

As shown in FIG. 3, VHT PPDU 320 includes an L-STF, an L-LTF, an L-SIG, a VHT Signal A field (VHT-SIG-A), a VHT Short Training field (VHT-STF), one or more VHT Long Training field (VHT-LTF), a VHT Signal B field (VHT-SIG-B) and a Data field. The VHT-LTF and Data fields of VHT PPDU 320 include one or more symbols each having a duration of 3.6 μs or 4 μs. In both cases, 3.2 μs carry symbol information while the remaining 0.4 μs or 0.8 μs carry of the GI. The 0.4 μs long GI is called the Short GI while the 0.8 μs long is called regular or normal GI. For VHT PPDUs, four bandwidths, 20 MHz, 40 MHz, 80 MHz, and 160 MHz, may be supported. When the PPDU bandwidth is 20 MHz, the band is divided into 64 subcarriers. When the PPDU bandwidth is 40 MHZ, the band is divided into 128 subcarriers. When the PPDU bandwidth is 80 MHz, the band is divided into 256 subcarriers. When the PPDU bandwidth is 160 MHz, the band is divided into two 256-subcarrier 80 MHz bands. In all cases, a subcarrier spacing of 312.5 kHz is maintained.

Extremely High Throughput (EHT) Multi-user (MU) PPDU 330 may be used by STAs conforming to the IEEE 802.11be standard amendment. EHT MU PPDU 530 supports OFDMA up to a bandwidth of 320 MHz. EHT MU PPDU 330 can improve spectral efficiency due to support of a higher order modulation compared to other PPDUs (e.g., HE SU PPDU 410 and HE MU PPDU 420) while supporting the same number of spatial streams. EHT MU PPDU 330 has a minimum preamble duration of 47.2 μs, which may increase depending on the number of spatial streams carried by the PPDU.

As shown in FIG. 3, EHT MU PPDU 330 includes an L-STF, an L-LTF, an L-SIG, a Repeated L-SIG (RL-SIG), a Universal Signal field (U-SIG), an EHT Signal Field B (EHT-SIG-B), an EHT Short Training Field (EHT-STF) field, one or more EHT Long Training fields (EHT-LTF), a Data field, and a Packet extension (PE) field. It is noted that according to the IEEE 802.11be standard amendment, EHT MU PPDU 330 may be used by a transmitting STA for both SU and MU transmissions.

EHT-SIG in EHT MU PPDU 330 contains indications per STA of resource unit (RU) allocations. A STA may use the indications in EHT-SIG to locate its payload in EHT MU PPDU 530.

In addition, EHT MU PPDU 330 contains a U-SIG that ensures forward compatibility of EHT MU PPDU 330. This means that any future PPDUs that are backward compatible to IEEE 802.11be will contain the same U-SIG field and interpretation. Because of this, IEEE 802.11be STAs will be able to understand at least in part a PPDU developed in a future amendment.

The GI portion of the EHT-LTF and Data field of EHT MU PPDU 330 may be one of: 0.8 μs, 1.6 μs, or 3.2 μs. An AP or STA may use a suitable GI duration depending on the channel conditions or capability of the target STA or AP.

The information portion of the EHT-LTF may be one of 3.2 μs, 6.4 μs, or 12.8 μs. Depending on the information portion duration, a subcarrier spacing of the EHT-LTF may be one of: 312.5 kHz if the information potion is 3.2 μs, 156.25 kHz if the information portion is 6.4 μs, or 78.125 kHz if the information portion is 12.8 μs.

The information portion of the Data field of EHT MU PPDU 330 is always 12.8 μs. Hence, a subcarrier spacing of the Data field is always 78.125 kHz corresponding to the duration of the information portion being 12.8 μs.

When a 3.2 μs long or a 6.4 μs long EHT-LTF is used by a transmitting STA to transmit EHT MU PPDU 330, a receiving STA is required to interpolate the channel estimates to a subcarrier spacing resolution of 78.125 kHz to match the Data field subcarrier spacing.

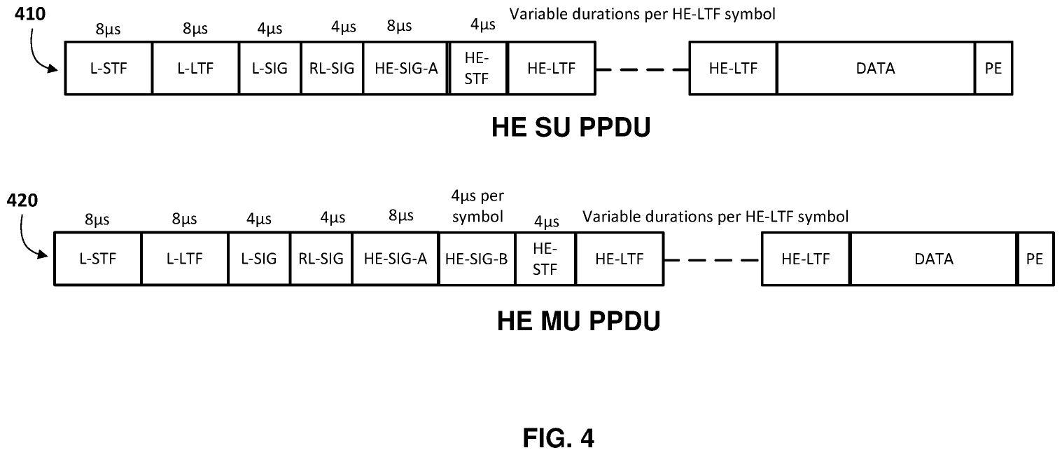

FIG. 4 illustrates additional examples of PPDUs which may be used by a STA to transmit on a wireless medium using EDCA. High Efficiency (HE) Single User (SU) PPDU 410 and HE MU PPDU 420 may be used by STAs conforming to the IEEE 802.11ax standard amendment.

HE SU PPDU 410 supports higher spectral efficiency compared to VHT PPDU 320 due to increased subcarrier spacing and higher order modulation support. HE SU PPDU 410 has a minimum preamble duration of 44 μs.

As shown in FIG. 4, HE SU PPDU 410 includes an L-STF, an L-LTF, an L-SIG, an RL-SIG, an HE Signal A field (HE-SIG-A), an HE Short Training field (HE-STF) field, one or more HE Long Training field (HE-LTF), a Data field, and a PE field.

Similar to HE SU PPDU 410, HE MU PPDU 420 supports higher spectral efficiency compared to VHT PPDU 320. HE MU PPDU 420 also supports OFDMA. Due to denser subcarrier spacing (as in HE SU PPDU 310), HE MU PPDU 320 allows for payloads of multiple users to be multiplexed in the frequency domain in the Data field. HE MU PPDU 320 supports multiplexing the payload of up to 9 users in a single 20 MHz band. HE MU PPDU 420 has a minimum preamble duration of 47.2 μs, which may increase depending on the number of spatial streams carried by the PPDU.

As shown in FIG. 4, HE MU PPDU 420 includes an L-STF, an L-LTF, an L-SIG, an RL-SIG, an HE-SIG-A, an HE Signal B Field (HE-SIG-B), an HE-STF field, one or more HE-LTF field, a Data field, and a PE field. It is noted that compared to HE SU PPDU 410, HE MU PPDU 420 further includes HE-SIG-B. HE-SIG-B contains indications per STA of RU allocations. A STA may use the indications in HE-SIG-B to locate its payload in HE MU PPDU 420.

For HE SU PPDU 410 and HE MU PPDU 420, the GI portion of the HE-LTF and Data field may be one of one of 0.8 μs, 1.6 μs, and 3.2 μs. An AP or STA may use a suitable GI duration depending on the channel conditions or capability of the target STA or AP.

For both HE SU PPDU 410 and HE MU PPDU 420, the information portion of the HE-LTF may be one of 3.2 μs, 6.4 μs, or 12.8 μs. Depending on the information portion duration, a subcarrier spacing of the HE-LTF may be one of: 312.5 kHz if the information potion is 3.2 μs, 156.25 kHz if the information portion is 6.4 μs, and 78.125 kHz if the information portion is 12.8 μs.

Contrary to the HE-LTF however, the information portion of the Data field for both HE SU PPDU 410 and HE MU PPDU 420 is always 12.8 μs. Hence, a subcarrier spacing of the Data field is always 78.125 kHz corresponding to the duration of the information portion being 12.8 μs.

When a 3.2 μs or 6.4 μs long HE-LTF is used by a transmitting STA to transmit HE SU PPDU 410 or HE MU PPDU 420, a receiving STA is required to interpolate the channel estimates to a subcarrier spacing resolution of 78.125 kHz to match the subcarrier spacing of the Data field.

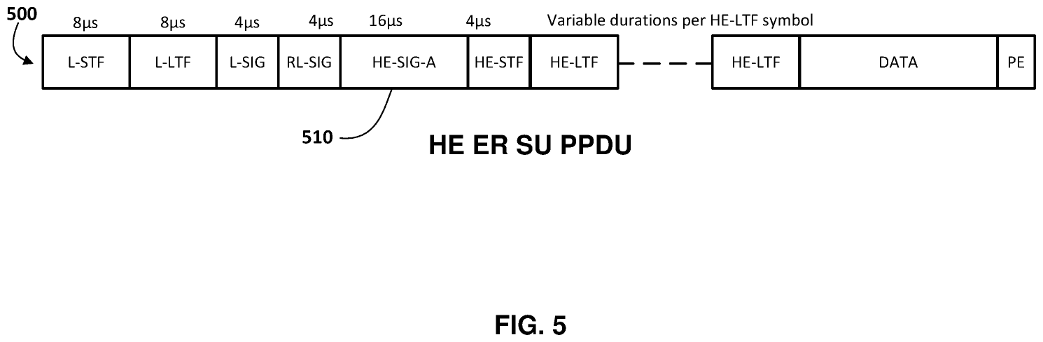

FIG. 5 illustrates an example HE Extended Range (ER) SU PPDU 500. Similar to the PPDUs discussed above, HE ER SU PPDU 500 may be used by a STA to transmit on the wireless medium using EDCA. As shown in FIG. 5, HE ER SU PPDU 500 includes an L-STF, an L-LTF, an L-SIG, an RL-SIG, an HE-SIG-A 510, an HE-STF, one or more HE-LTF, a Data field, and a PE field. It is noted that compared to HE SU PPDU 410, HE ER SU PPDU 500 has an HE-SIG-A 510 that is duplicated in the time domain (16 μs long instead of 8 μs long in HE SU PPDU 410). As such, both L-SIG (duplicated using RL-SIG) and HE-SIG-A are sent in duplicates, which allows a receiving STA to combine the two copies to increase the energy of the received signal. This results in an extended range of reception and increases transmission reliability between the transmitting STA and the receiving STA.

While not currently supported in the IEEE 802.11be standard amendment, an EHT SU PPDU may also be generated by duplicating the 8 μs U-SIG field EHT MU PPDU 330 to 16 μs.

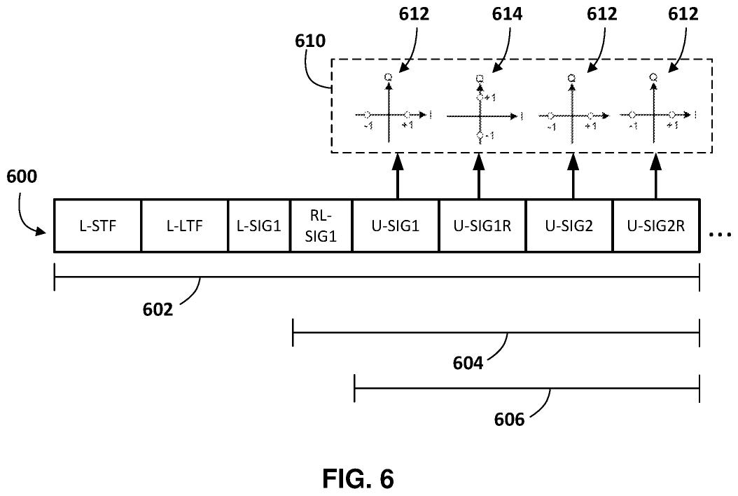

Referring to FIG. 6, an example EHT PPDU 600 includes a preamble 602 that extends the range of the EHT PPDU 600. In the example, the preamble 602 includes legacy fields including an L-STF, an L-LTF, an L-SIG field. The EHT PPDU 600 may include extended range fields 604 including an RL-SIG field and a U-SIG field 606 including 2 symbols: U-SIG symbol 1 (U-SIG1) and U-SIG symbol 2 (U-SIG2), and copies (or additional repetitions) of each of the 2 symbols: U-SIG symbol 1 repetition (U-SIG1R) and U-SIG symbol 2 repetition (U-SIG2R). Use of repetitions may result in extending a range of reception and increasing transmission reliability between an AP and STAs.

Determination of whether a preamble is an extended range preamble or not by a receiving STA may be based on the use of modulation schemes, interleaving, and constellations, and other techniques may be used to encode a signal field of a PPDU. In an aspect, one or more modulation techniques, such as binary phase-shift keying (BPSK) or quadrature BPSK (QBPSK), are used to encode each symbol and repetition. A modulation scheme may include an interleaving technique having a constellation, and, for diversity different modulation schemes may be applied to a symbol and the respective repetition of the symbol. In an example, when encoding U-SIG field 606 with a modulation scheme, constellations 610 are used. In this example, a first modulation scheme (e.g., BPSK) having a first constellation 612 is applied to U-SIG1, and a second modulation scheme (e.g., QBPSK) having second constellation 614 is applied to U-SIG1R to increase diversity. Use of constellation switching (e.g., first constellation 612 to second constellation 614) may indicate that U-SIG1R is a copy (or repetition) of U-SIG1. Further, based on U-SIG1 having a same number of repetitions as a U-SIG, modulation schemes and constellations between U-SIG2 and U-SIG2R may remain the same.

In an aspect, ultra-high reliability (UHR) WLAN may include millimeter wave (mmWave) operation that includes 60 GHz interface for mainstream wireless signals. A mmWave operation may reuse low band baseband and design as much as possible to lower costs and case of integration, and reach 6 G latency objectives with more guarantees,

The IEEE 802.11ad standard may use the mmWave operation to incorporate use of a 60 GHz spectrum. 60 GHz propagation may result in a large free space path loss (e.g., 22 dB higher than a 5 GHz spectrum), a lower transmit power (e.g., −6 dB), and a higher noise figure (e.g., −3 dB), as compared to other propagations used by the IEEE 802.11 standards.

In an aspect, a physical layer design for orthogonal frequency division multiple (OFDM) operation for different bandwidths (e.g., between 160 MHz and 1280 MHZ) may reuse lower band design as much as possible through uplocking. The physical layer design may include simple beamforming training sequences and minor adaptations to multi-link operation. Beamtraining (or beamforming training) may include a bidirectional sequence of frame transmissions (or beamforming frame transmissions) that provide the necessary signaling to allow each STA to determine appropriate antenna system settings for both transmission and reception in the mm Wave bands. After successful completion, beamtraining is said to be established. Use of mmWave operation may also build on lower band channelization and use a base (e.g., smallest) channel bandwidth of 80 MHz, 160 MHZ, or 320 MHz.

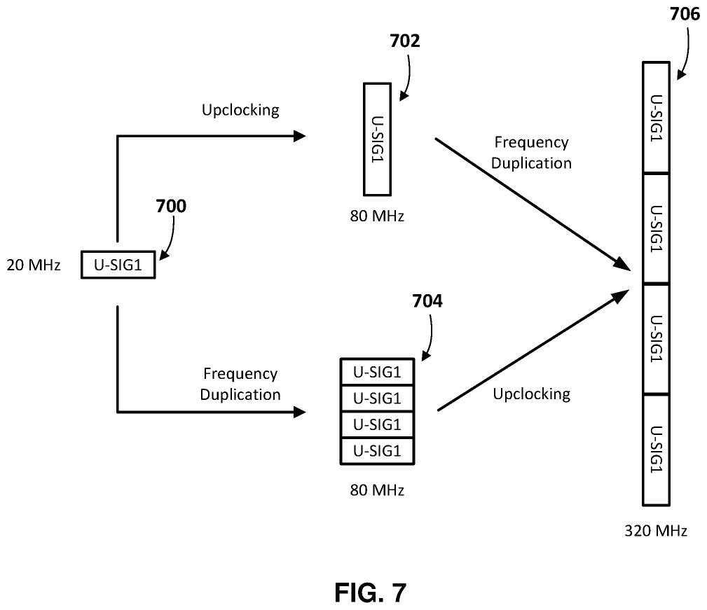

In an aspect, a preamble design for UHR supporting mmWave operation may contain a non-UHR portion and a UHR portion. The non-UHR portion may be similar to preamble 602 shown in example EHT PPDU 600 in FIG. 6. The encoding procedure for each symbols of the non-UHR portion may also be similar to the encoding of corresponding symbols of an EHT PPDU but may include further processing (e.g. uplocking or repetition to increase the preamble bandwidth). Following the non-UHR portion, a UHR portion may follow which may include new preamble symbols to support a future UHR feature. The encoding procedure for the UHR portion of a UHR preamble may be different from the encoding procedure for the non-UHR portion. Referring to FIG. 7, different techniques may be used to encode non-UHR fields of a mmWave PPDU. In an example, encoding U-SIG1 700 (e.g., non-UHR field) for transmitting in a higher bandwidth (e.g., 80 MHZ) than a 20 MHZ PPDU bandwidth may be performed by an upclocking operation, a frequency duplication operation, or a combination of upclocking operations and frequency duplication operations. For example, U-SIG1 700 is upclocked to 80 MHz by increasing the subcarrier spacing to generate upclocked symbol U-SIG1 702. In comparison to frequency duplication, uplocking may result in lower robustness, due to lower power spectral density, but may be less complex to implement. In another example, U-SIG1 700 is duplicated in the frequency domain to generate frequency duplicated symbol U-SIG1 704 totaling 80 MHZ (e.g., four frequency duplicates of U-SIG1 700). As compared to upclocking, frequency duplicating may result in higher robustness, when maximal ratio combining is used, but may be more complex to implement. Further, for high bandwidths, U-SIG1 700 may be upclocked and then frequency duplicated or U-SIG1 700 may be frequency duplicated and then upclocked to generate upclocked and frequency generated symbol U-SIG1 706 that is 320 MHz. When combining operations, both upclocking and frequency duplication may be performed simultaneously to generate U-SIG1 706.

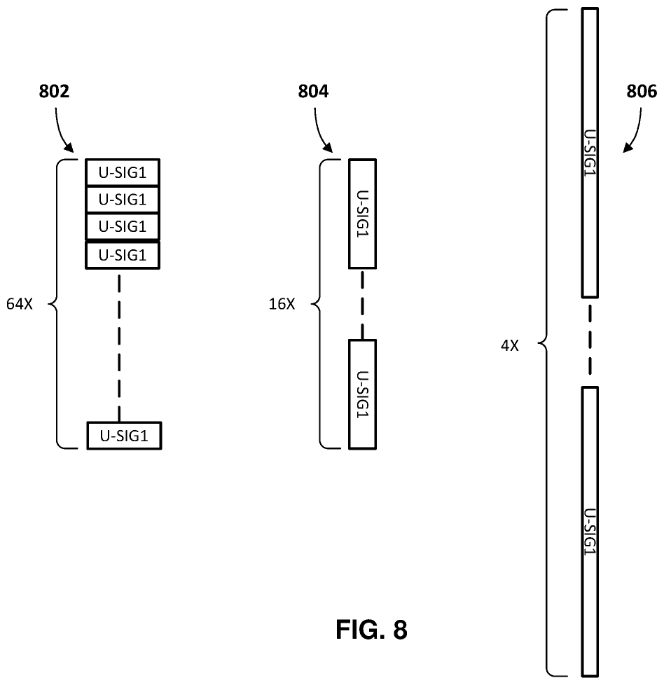

UHR mmWave operation may reach up to 1.28 GHz. In existing technologies, a fully duplicated signal field of a preamble of a mmWave PPDU will need as many as 64 duplicates of U-SIG, UHR-SIG, etc. For example, referring to FIG. 8, signal field 802 may be generated when U-SIG1 has a base bandwidth of 20 MHZ and is duplicated 64 times, which may result in a significant amount of parallel computations. Uplocking OFDM symbols, according to existing technologies, may reduce parallel computations. For example, as shown by FIG. 8, signal field 804 may be generated when U-SIG1 has a base bandwidth of 80 MHZ and is duplicated 16 times, resulting in 75% less complexity than encoding for signal field 802, and signal field 806 may be generated when U-SIG1 has a base bandwidth of 320 MHZ and duplicated 4 times resulting in 94% less complexity than encoding for signal field 802. However, upclocking may come at the expense of lower reliability. for example, as compared to signal field 802, signal field 804 may result in 6 dB less reliability and signal field 806 may result in 12 dB less reliability. Accordingly, there is a need in encoding technologies to reduce the complexity of encoding without losing reliability.

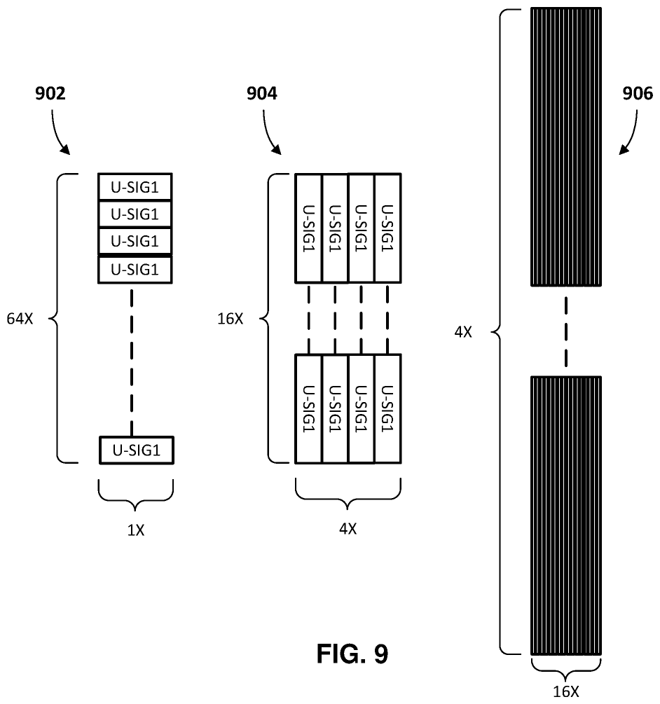

The present disclosure provides techniques for flexible frequency domain and time domain repetitions of signal fields. In an aspect, an AP (or transmitting STA) may perform repetitions of both time and frequency of header symbols depending on capabilities of a receiving STA as well as channel conditions, to maintain reliability and lower complexity while encoding. Referring to FIG. 9, example techniques may be used to encode signal fields of a preamble to reach a PPDU bandwidth (e.g., 1.28 GHZ) according to a combination of A×B, where A is a number of frequency domain duplications and B is a number of time domain repetitions. Signal field 902 is an example of U-SIG1, at a base bandwidth of 20 MHZ, being encoded with 64×1 duplicates (e.g., 64 frequency domain duplications, 1 time domain repetition). Signal field 904 is an example of U-SIG1, at a base bandwidth of 80 MHz, being encoded with 16×4 duplicates (e.g., 16 frequency domain duplications, 4 time domain repetitions). Signal field 906 is an example of U-SIG1 being encoded with 4×16 duplicates (e.g., 4 frequency domain duplications, 16 time domain repetitions). In comparison with signal field 902, signal field 904 and signal field 906 may maintain the same reliability and lower encoding complexity by 75% and 94%, respectively. Further, implementation of embodiments provided by this disclosure allow a receiving STA to autodetect how many repetitions are sent by a transmitting STA, as disclosed below.

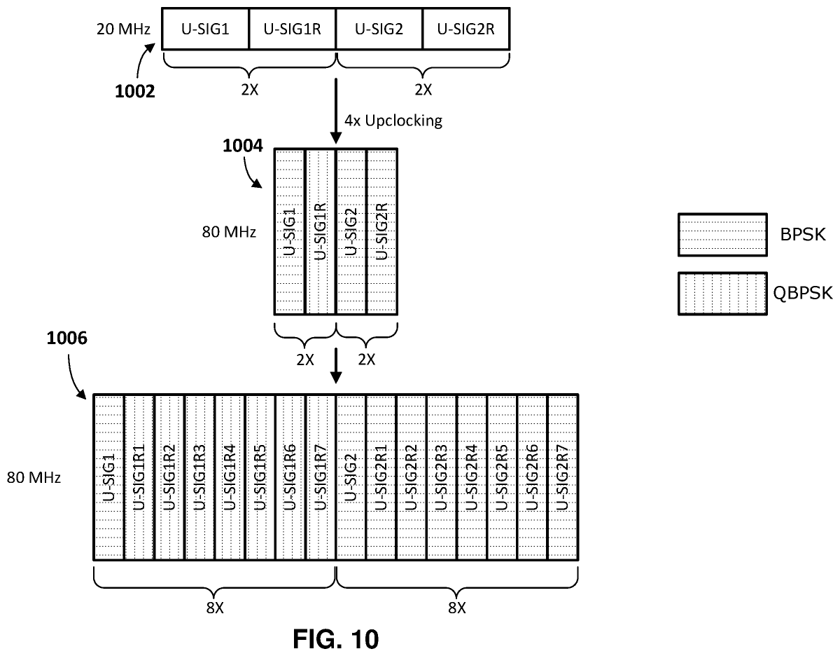

Referring to FIG. 10, an example of flexible time domain repetition allows an EHT extended range signal field 1002 to flexibly extend to a UHR mmWave preamble. For example, EHT extended range signal field 1002, having a 20 MHz base bandwidth and 2 repetitions of each symbol, may extend to signal field 1004 and/or to preamble 1006. In an aspect, a transmitting STA or AP generates signal field 1004 by upclocking the 20 MHz bandwidth of U-SIG1, U-SIG1R, U-SIG2, and U-SIG2R of the signal field 1002 four times to reach 80 MHZ. Due to the upclocking, the duration of signal field 1004 will be four times shorter than signal field 1002. The transmitting STA or AP also applies a first modulation scheme (e.g., BPSK) to U-SIG1, U-SIG2, and U-SIG2R, and applies a second modulation scheme (e.g., QBPSK) to U-SIG1R. Based on this example, a receiving STA determines the U-SIG1R is a repetition based on the change in modulation schemes. Further, the receiving STA determines that the U-SIG1R has finished based on a subsequent symbol, U-SIG2, starting with a different modulation scheme. The receiving STA also determines U-SIG2R is a repetition of U-SIG2 based on U-SIG2 having the same number of repetitions (e.g., two repetitions) as U-SIG1.

To generate signal field 1006, the transmitting STA or AP upclocks U-SIG1, U-SIG1R, U-SIG2, and U-SIG2R of the signal field 1002 four times to reach 80 MHz or maintains the base bandwidth at 80 MHz if transitioning from signal field 1004. Further, the transmitting STA or AP generates seven time domain repetitions of U-SIG1 and U-SIG2. U-SIG1, U-SIG2, and each of the repetitions of U-SIG2 (e.g., U-SIG2R1-U-SIG2R7) are also encoded by the transmitting STA or AP using the first modulation scheme (e.g., BPSK) and U-SIG1R1-U-SIG1R7 are encoded using the second modulation scheme (e.g., QBPSK). Based on this example, a receiving STA determines U-SIG1R1 is a repetition of U-SIG1 based on the change in modulation schemes. Further, the receiving STA determines that the U-SIG1R2-U-SIG1R7 are additional repetitions as they maintain the same modulation scheme as U-SIG1R1. The receiving STA also determines the repetitions of U-SIG1 have finished based on a subsequent symbol, U-SIG2, of U-SIG1R7 starting with a different modulation scheme. The receiving STA determines U-SIG2R1-U-SIG2R7 are repetitions of U-SIG2 based on U-SIG2 having the same number of repetitions (e.g., 8 repetitions) as U-SIG1.

In an example, to increase diversity, interleaving may also be applied by the transmitting STA or AP to increase diversity. For example, the transmitting STA or AP may use a second interleaving scheme (e.g., not interleaving) for at least one repetition of U-SIG that is different from a first interleaving scheme (e.g., interleaving) for the first U-SIG. In this example, a receiving STA may determine a repetition of U-SIG1 (e.g., U-SIG1R or U-SIG1R2) is a repetition of U-SIG1 based on the interleaving switching (e.g., interleaved to not interleaved) between U-SIG1 and the repetition. The receiving STA may determine additional symbols are additional repetitions of U-SIG1 (e.g., U-SIG1R2-U-SIG1R7) based on the same interleaving (e.g., not interleaved) being used for each of the these repetitions. The receiving STA may also determine when the repetitions of U-SIG1 are finished due to the interleaving switching (e.g., not interleaved to interleaved) between a last repetition (e.g., U-SIG1R or U-SIG1R7) and U-SIG2.

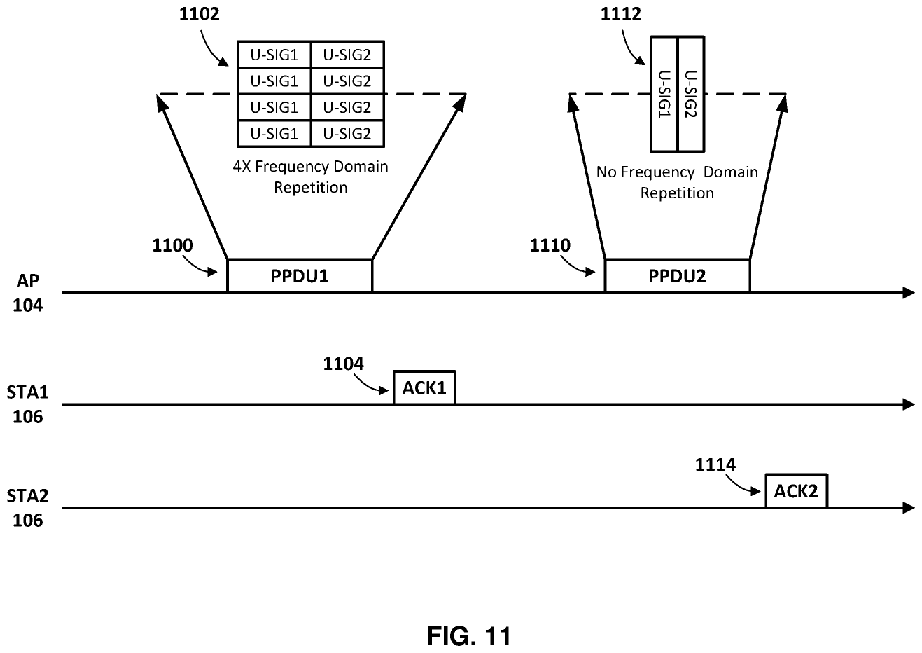

Referring to FIG. 11, an example channel access operation using flexible frequency domain repetition may be performed by AP 104, STA1 106, and STA2 106. In an example, STA1 106 may have a stronger channel to and from AP 104 compared to STA2 106. In an example, AP 104 may transmit a mmWave PPDU1 1100, having a preamble with a signal field 1102 with frequency domain repetitions (e.g., four), and STA1 may subsequently transmit ACK1 1104 to acknowledge mmWave PPDU1 1100. In another example, the AP 104 may subsequently transmit a mmWave PPDU2 1110, having a signal field 1112 with no frequency domain repetitions, and STA2 may subsequently transmit ACK2 1114 to acknowledge mmWave PPDU2 1110.

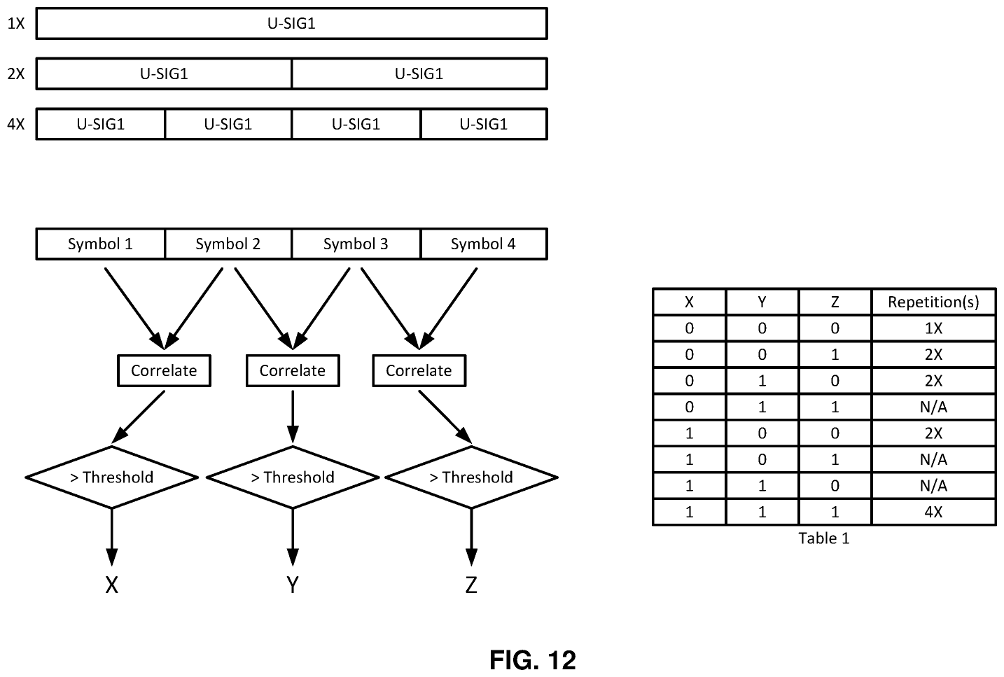

Referring to FIG. 12, a receiving STA may autodetect frequency domain repetitions of a signal field of a mmWave PPDU. In an aspect, a receiving STA may look at sequential symbols to determine if there is a correlation of these symbols, and, based the correlation(s) of the symbols being greater than a threshold, determine which symbols are repeated in the frequency domain.

In an example, as illustrated by FIG. 12, a minimum number of repetitions of frequency domain repetitions is one and a maximum number of frequency domain repetitions is four. Based on this example, a number of frequency domain repetitions for a UHR symbol is one (e.g., 1× repetition of U-SIG1), two (e.g., 2× repetitions of U-SIG1), or four (e.g., 4× repetitions of U-SIG1). For autodetection, the receiving STA determines correlations between symbol 1 and symbol 2, symbol 2 and symbol 3, and symbol 3 and symbol 4. A correlation between symbols may be determined, for example, based on an inner product (i.e., X^{H}Y where X and Y are column vectors of two symbols and H is the Hermitian transpose) of the time domain samples of the symbols. Further, each correlation is compared to a threshold to determine the likelihood of the symbols being the same. If a correlation between symbols is greater than the threshold, the outcome (e.g., X, Y, Z) of the threshold comparison is 1, otherwise the outcome is 0. Accordingly, the receiving STA may autodetect a number of frequency domain repetitions according to Table 1.

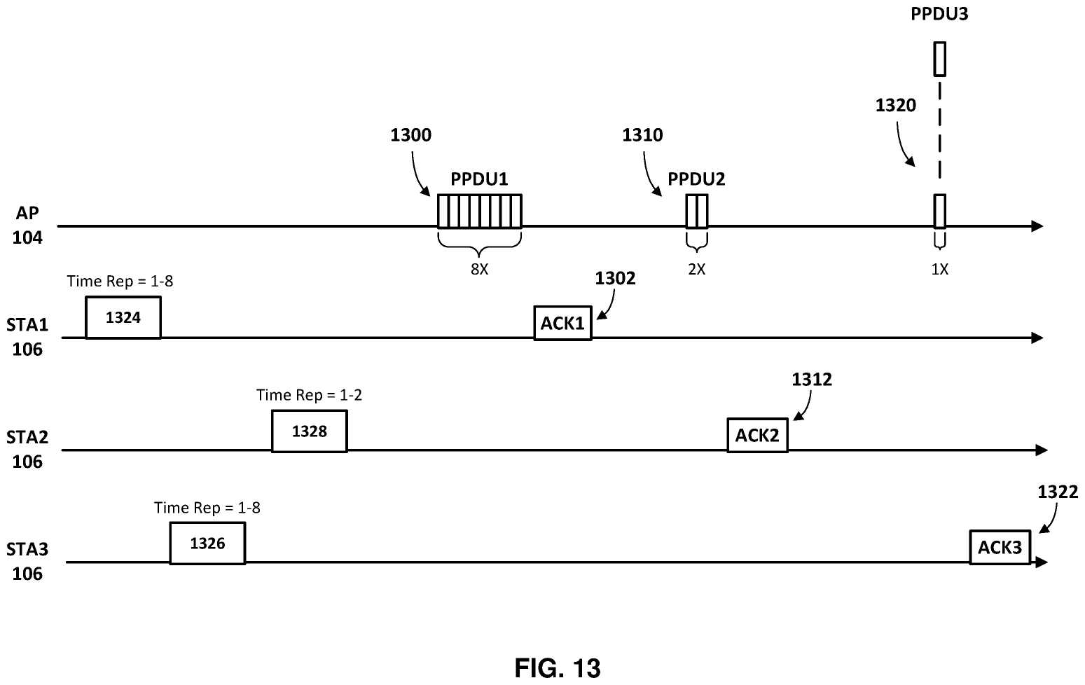

Referring to FIG. 13, an example channel access operation for fixed frequency domain, flexible time domain repetition is illustrated. In an aspect, an AP may transmit, and a STA may receive, a PPDU at a minimum PPDU bandwidth with an increased/reduced number of signal field time domain repetitions based on a link quality. When the link quality is low, an AP may choose to transmit using the minimum PPDU bandwidth. Aside from using the minimum PPDU bandwidth, the AP can further improve the link quality by transmitting with increased time domain repetitions. In an aspect, the number of time domain repetitions that an AP may use may depend on the capability of the receiving STA. In an example, a 60 GHz signal field (e.g., U-SIG) is received with a minimum 80 MHz bandwidth. Further, the allowed time domain repetitions may be from one up to eight repetitions. STA1 106, STA2 106, and STA3 106 provide examples of stations receiving a PPDU with increased (e.g., 60 GHZ) link quality and based on fixed frequency domain, flexible time domain repetitions. In a first example, the 60 GHz link between AP 104 and STA1 106 has a low power concentration (e.g., low received signal strength indicator (RSSI)) and is not 60 GHz beamtrained. In other words, STA1 106 has not successfully determined appropriate antenna system settings to communicate in the 60 GHz bandwidth. Accordingly, AP 104 may transmit PPDU1 1300 to STA1 106 with the minimum PPDU bandwidth (e.g., 80 MHz PPDU bandwidth) and eight time domain repetitions (e.g., maximum time domain repetitions) of the signal field of the preamble of PPDU1 1300 for maximum boosting of the link quality. As shown in FIG. 13, the use of eight time domain repetitions is based on AP 104 knowing that STA1 106 is capable of receiving eight repetitions, as indicated by STA1 106 in frame1 1324. STA1 106 may subsequently transmit ACK1 1302 to acknowledge PPDU1 1300.

As illustrated by FIG. 13, in a second example, the 60 GHz link between AP 104 and STA2 106 also has a low power concentration (e.g., low RSSI) but is 60 GHz beamtrained. In other words, STA2 106 has successfully determined appropriate antenna system settings to communicate in the 60 GHz bandwidth. In this case, AP 104 may transmit PPDU2 1310 to STA2 106 with a PPDU bandwidth 80 MHz because of a low power concentration (e.g., low RSSI) but the time domain repetitions of signal field may be two. As shown in FIG. 13, the use of two time domain repetitions is based on AP 104 knowing that STA2 106 is capable of receiving two repetitions, as indicated by STA2 106 in frame3 1328. STA2 106 may subsequently transmit ACK2 1312 to acknowledge PPDU2 1310. In a third example, the 60 GHz link between AP 104 and STA3 106 has a high power concentration (e.g., high RSSI) and is 60 GHz beamtrained. In other words, STA3 106 has successfully determined appropriate antenna system settings to communicate in the 60 GHz bandwidth. Accordingly, STA3 106 receives PPDU3 1320 at 1.28 GHz PPDU bandwidth with one time domain repetition of the signal field of the preamble. As shown in FIG. 13, the use of one time domain repetition is based on AP 104 knowing that STA3 106 is capable of receiving one repetition, as indicated by STA3 106 in frame2 1326. STA3 106 may subsequently transmit ACK3 1322 to acknowledge PPDU3 1320. In this example, PPDU3 1320 may result in a better quality signal with the least amount of overhead, as compared to the operation between AP 104 and STA1 106 and the operation of AP 104 and STA2 106.

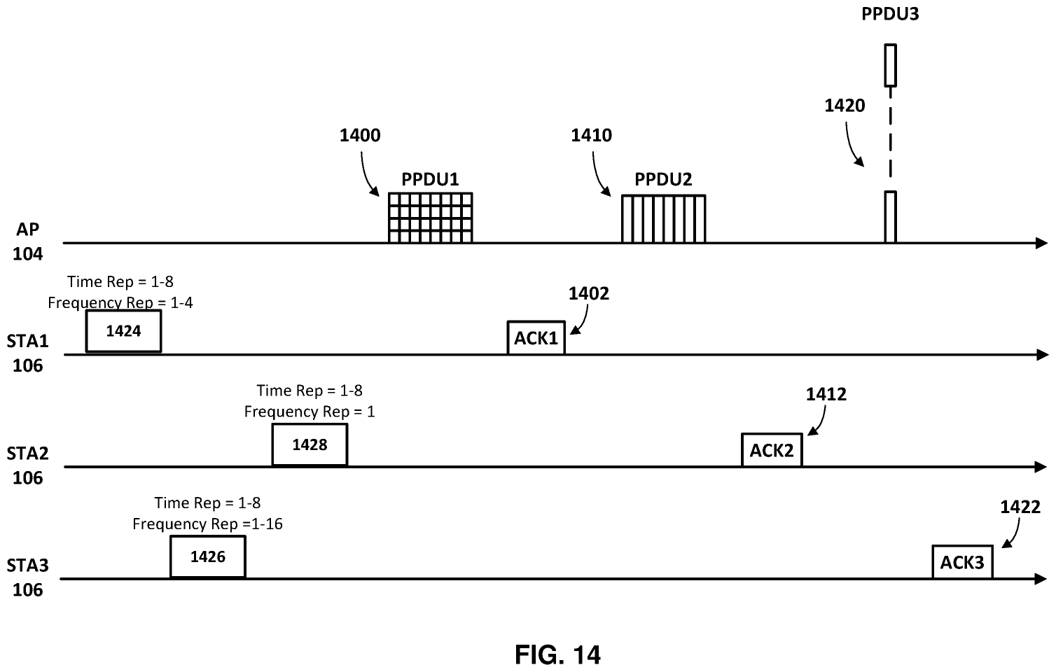

Referring to FIG. 14, example channel access operations for flexible frequency domain, flexible time domain repetition allow an AP to transmit, and a STA to receive, a PPDU at a reduced/increased PPDU bandwidth with an increased/reduced number of preamble frequency domain and time domain repetitions based on a link quality. When the link quality is low, an AP may choose to transmit with increased frequency domain repetitions by using a smaller base bandwidth. Aside from using increased frequency domain repetitions, the AP can further improve the link quality by transmitting with increased time domain repetitions. In an aspect, the number of frequency domain repetitions and time domain repetitions that an AP may use may depend on the capability of the receiving STA. In an example, frequency domain repetitions in an 80 MHz bandwidth may be one, two, or four repetitions (e.g., base bandwidth is 80 MHz, 40 MHz or 20 MHZ) and time domain repetitions may be up to eight time domain repetitions. STA1 106, STA2 106, and STA3 106 provide examples of stations reacting differently according to increasing mmWave (e.g., 60 GHZ) link quality, based on flexible frequency domain, flexible time domain repetition techniques. In a first example, the 60 GHZ link between AP 104 and STA1 106 has a low power concentration (e.g., low received signal strength indicator (RSSI)) and is not 60 GHz beamtrained. In other words, STA1 106 has not successfully determined appropriate antenna system settings to communicate in the 60 GHZ bandwidth. In this example, PPDU1 1400 may be transmitted by AP 104, and received by STA1 106, with an 80 MHz PPDU bandwidth and with four frequency domain repetitions (e.g., 20 MHz base bandwidth) of a signal field of a preamble of the PPDU1 1400, and eight time domain repetitions (e.g., maximum time domain repetitions) of the signal field for maximum boosting of the link quality. As shown in FIG. 14, the use of four frequency domain repetitions and eight time domain repetition is based on AP 104 knowing STA1 106 is capable of receiving four frequency domain repetitions and eight time domain repetitions, as indicated by STA1 106 in frame1 1424. STA1 106 may subsequently transmit, and AP 104 may receive, ACK1 1402 to acknowledge PPDU1 1400. Compared to PPDU1 1300 shown in FIG. 13 which only has an effective eight time domain repetitions, PPDU1 1400 having an effective 32 total repetitions (i.e., eight time domain repetitions and four frequency domain repetitions) may increase reception success.

As illustrated by FIG. 14, in a second example, the 60 GHz link between AP 104 and STA2 106 also has a low power concentration (e.g., low RSSI) but is 60 GHz beamtrained. In other words, STA2 106 has successfully determined appropriate antenna system settings to communicate in the 60 GHz bandwidth. In this case, the bandwidth for PPDU2 1410, when transmitted by AP 104 and received by STA2 106, may be 80 MHz without frequency domain repetitions (e.g., 80 MHz base bandwidth) because of the beamtraining gain. Hence, a signal field of a preamble of PPDU2 1410 may include eight time domain repetitions and one frequency domain repetition. As shown in FIG. 14, the use of one frequency domain repetition and eight time domain repetitions is based on AP 104 knowing that STA2 106 is capable of receiving one frequency domain repetition and eight time domain repetitions, as indicated by STA2 106 in frame3 1428. STA2 106 may subsequently transmit, and AP 104 may receive, ACK2 1412 to acknowledge PPDU2 1410. In a third example, the 60 GHz link between AP 104 and STA3 106 has a high power concentration (e.g., high RSSI) and is 60 GHZ beamtrained. In other words, STA3 106 has successfully determined appropriate antenna system settings to communicate in the 60 GHz bandwidth. Accordingly, AP 104 transmits, and STA3 receives, PPDU3 1420 at 1.28 GHz PPDU bandwidth with the signal field of the preamble of PPDU3 1420 having one time domain repetition and 16 frequency domain repetitions. As shown in FIG. 14, the use of 16 frequency domain repetitions and one time domain repetition is based on AP 104 knowing that STA3 106 is capable of receiving 16 frequency domain repetitions and eight time domain repetitions, as indicated by STA3 106 in frame2 1426. In this example, PPDU3 1420 may result in a better quality signal with the least amount of overhead, as compared to the examples of PPDU1 1400 and PPDU2 1410. STA3 106 may subsequently transmit, and AP 104 receives, ACK3 1422 to acknowledge PPDU3 1420.

In an aspect, a capability exchange may occur between a STA and an AP to indicate the STA's capability to communicate with a range (or number) time domain repetitions and/or a range (or number) frequency domain repetitions and/or the AP's designated range (or number) time domain repetitions and/or range (or number) frequency domain repetitions to be used for all transmissions. In an example, a STA provides capability information, to an AP, indicating the STA's capabilities to receive a signal field of a preamble of a PPDU with a range (or number) of time domain repetitions and/or a range (or number) of frequency domain repetitions. The capability information may be transmitted during an association phase of the STA and the AP. For example, the STA transmits capability information to the AP in an association request (or frame including an association request).

In response to the capability information, the AP may transmit all subsequent transmissions based on the indicated a range (or number) of time domain repetitions and/or a range (or number) of frequency domain repetitions. Alternatively, in response to the capability information and based on a capability information from a plurality of STAs, the AP may transmit a beacon (or frame) indicating a designated range (or number) of time domain repetitions and/or range (or number) of frequency domain repetitions for transmitting signal fields of a PPDU. In this case, the AP may take into account, for example, the capabilities of a STA, of the plurality of STAs, having a lowest range (or number) of time domain repetitions and/or a lowest range (or number) of frequency domain repetitions.

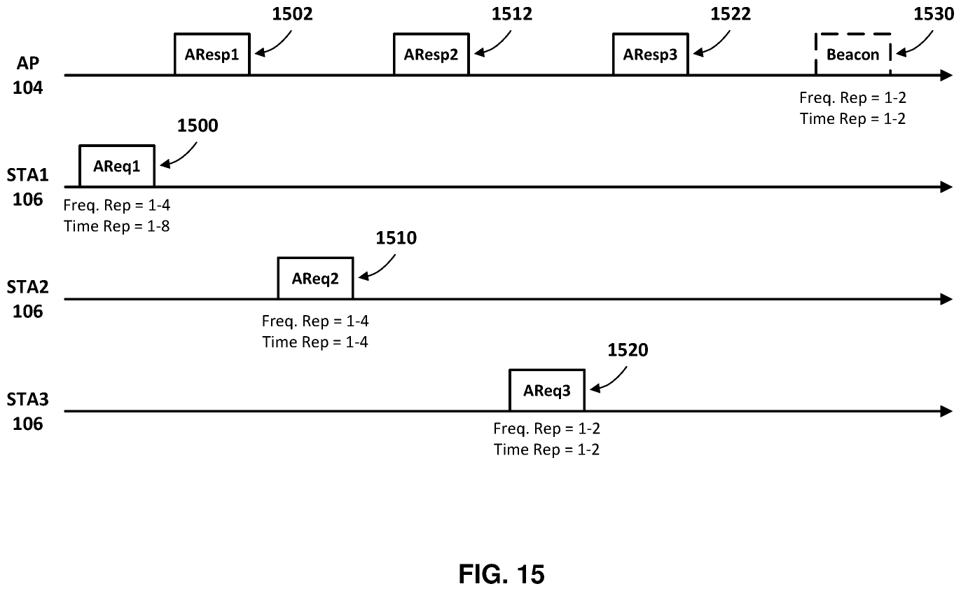

Referring to FIG. 15, an example of STA1 106, STA2 106, and STA3 106 associating with AP 104, includes each of these stations transmitting an association request (or AReq or frame) to AP. The association request may include capability information indicating a respective STA's capability to communicate with time domain repetitions and/or frequency domain repetitions. For example, STA1 106 initiates an association with the AP 104 by transmitting AReq1 1500, which indicates STA1's capability to receive a signal field, of a PPDU, with 1-4 frequency domain repetitions and 1-8 time domain repetitions. STA2 106 initiates an association with the AP 104 by transmitting, for example, AReq2 1510, which indicates capabilities of STA2 106 to receive a signal field, of a PPDU, with 1-4 frequency domain repetitions and 1-4 time domain repetitions. STA3 106 initiates an association with the AP 104 by transmitting, for example, AReq3 1520, which indicates capabilities of STA3 106 to receive 1-2 frequency domain repetitions and 1-2 time domain repetitions.

In response to each association request, AP 104 may transmit respective associating responses, AResp1 1502, Assoc. Resp2 1512, and Assoc. Resp3 1522, to confirm associations with STA1 106, STA2 106, and STA3 106. Subsequently, transmissions from AP 104 to STA1 106, STA2 106, and STA3 106 may be encoded according to respective capability information indicated by AReq1 1500, ARcq2 1510, and ARcq3 1520.

Alternatively, in response to the associating request, AP 104 may transmit a beacon 1530 to inform STA1 106, STA2 106, and STA3 106 of a number of time domain repetitions and/or frequency domain repetitions or a range of time domain repetitions and/or frequency domain repetitions to use for all transmission. In an example, beacon 1530 is transmitted based on STA1 106, STA2 106, and STA3 106 being within a BSS. As an example, AP 104 may transmit beacon 1530, to all stations in the BSS, which indicates that all transmissions in the BSS should stay within 1-2 frequency domain repetitions and 1-2 time domain repetitions in order to accommodate the capabilities of STA3 1520 for all transmissions.

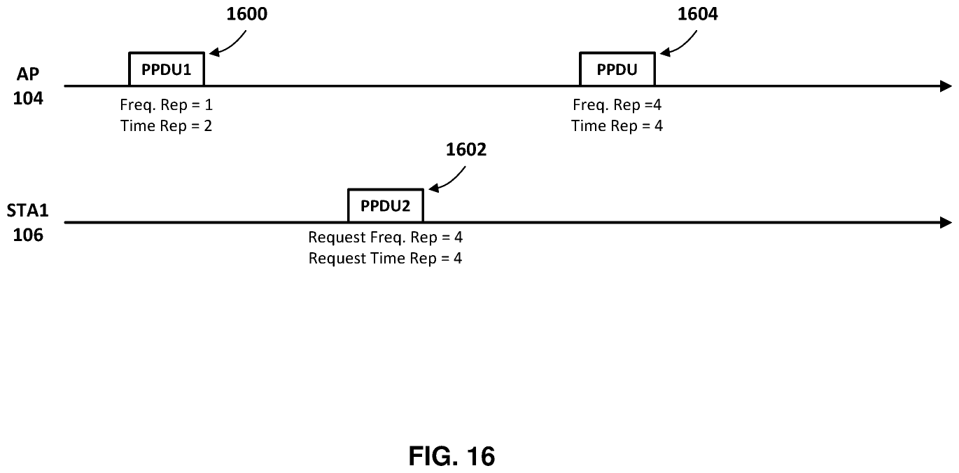

In an aspect, a STA may provide repetition feedback, in response to receiving a PPDU from an AP, to inform the AP of a preferred time domain repetition and/or frequency domain repetition. The repetition feedback may be in response to the STA determining the received PPDU has a low signal strength (e.g., RSSI). For example, referring to FIG. 16, AP 104 transmits, and STA1 106 receives, PPDU1 1600 with a time domain repetition of 2 and a frequency domain repetition of 1. Upon receipt of PPDU1 1600, STA1 106 determines the signal has a low RSSI. Based on the low RSSI of PPDU1 1600, STA1 106 may transmit PPDU2 1602 to inform AP 104 to transmit subsequent transmissions with a preferred time domain repetition of 4 and a preferred frequency domain repetition of 4. In response to PPDU2 1602, AP 104 may transmit subsequent transmissions, including PPDU3 1604, to STA1 106 with a time domain repetition of 4 and a frequency domain repetition of 4.

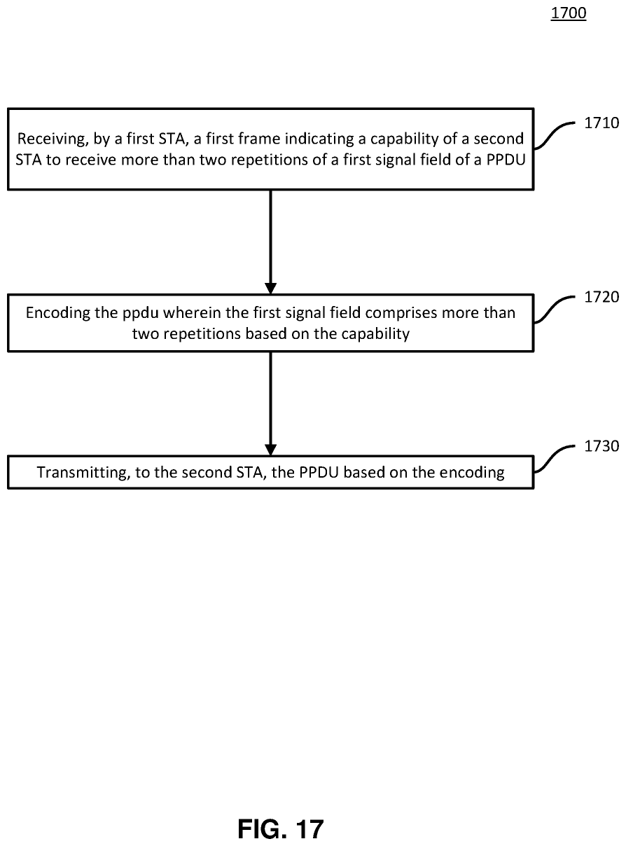

FIG. 17 an example process 1700 is provided for the purpose of illustration only and is not limiting of embodiments. Process 1700 may be performed by an AP or a STA (e.g., transmitting STA). In an example, the AP is a UHR AP. Process 1700 may be performed by the STA when transmitting a PPDU in a link with carrier frequencies higher than 10 GHz such as 45 GHz or 60 GHz.

As shown in FIG. 17, process 1700 may include operations 1710, 1720, and 1730. Operation 1710 may include receiving by a first STA, a first frame indicating a capability of a second STA to receive a number of repetitions of a first signal field of a PPDU. In an example, the number of repetitions is greater than two. The first STA may be a UHR AP while the second STA may be a non-AP STA associated with the UHR AP. Likewise, the first STA may be a UHR non-AP STA while the second STA may be a UHR AP to which the UHR non-AP STA is associated with.

In an example, the first signal field may include a first universal signal symbol (U-SIG 1) and a second universal signal symbol (U-SIG 2) both having a same number of repetitions. In an example, a first copy of the U-SIG1 may be based on a first modulation scheme and the subsequent repetitions may be based on a second modulation scheme different from the first modulation scheme. For example, the first modulation scheme may use BPSK modulation while the second modulation scheme may use QBPSK modulation.

In an example, the PPDU may include a second signal field, and the second signal field may be encoded with the same number of repetitions as the first signal field. For example, the second signal field may have the same number of repetitions as the repetitions of the U-SIG 1 or U-SIG 2. The second signal field may include at least one UHR signal field.

In an example, the first frame may include a first maximum number of time domain repetitions for the first signal field that the second STA can receive.

In an example, process 1700 may further include receiving by the first STA, from the second STA, a frame indicating a capability of the second STA to receive two or more repetitions in the frequency domain of the first signal field. This frame can be the first frame or a second frame different from the first frame. In an example, the first frame or the second frame further indicates a maximum number of frequency domain repetitions for the first signal field that the second STA can receive.

In an example, the second STA is a non-AP STA and the first STA is an AP. In this example, the first frame may be a beacon, association request, or an authentication response. Further, first STA may receive two or more first frames from two or more second STAs with indications of first maximum number of time domain repetitions. Based on these indications, the first STA may transmit a frame indicating to the one or more second STAs, comprising the second STA, of a second maximum number of time domain repetitions to use for all transmissions by the second STAs.

As shown in FIG. 17, operation 1720 may include encoding the PPDU such that the first signal field comprises up to the number of repetitions based on the capability indicated in the first frame. In an example, the first signal field is repeated in a frequency domain based on the maximum number of frequency domain repetitions indicated in the first frame or in the second frame. In another example, the repetitions of the first signal field is done in both time domain and frequency domain based on the indications in the first and second frames.

As shown in FIG. 17, operation 1730 may include transmitting, to the second STA, the PPDU, based on the encoding. In an example, process 1700 may further include receiving, by the first STA, from the second STA, a repetition feedback indicating a suggested number of repetitions of the first signal field for a subsequent PPDU transmission.

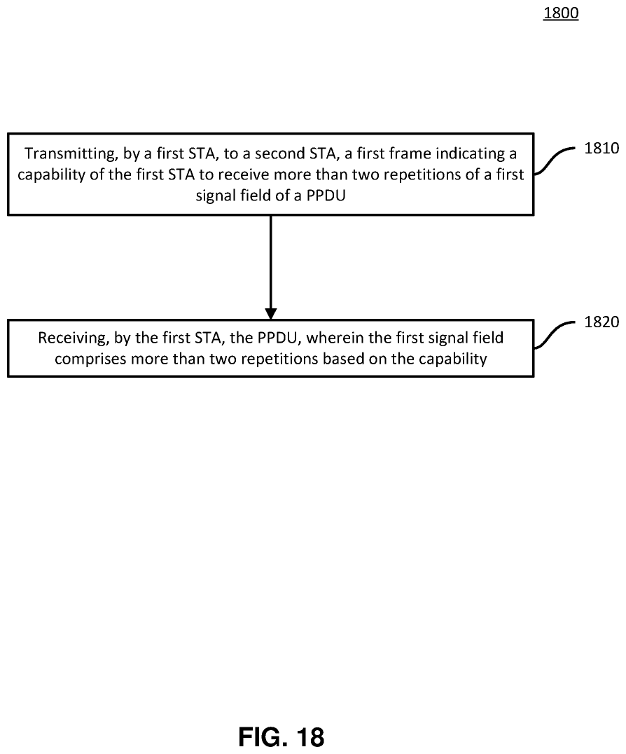

Referring to FIG. 18, an example process 1800 is provided for the purpose of illustration only and is not limiting of embodiments. Process 1800 may be performed by an AP or a STA (e.g., receiving STA). The AP may be a UHR AP for example. Process 1800 may be performed by the STA when transmitting a PPDU in a link with carrier frequencies higher than 10 GHz such as 45 GHz or 60 GHz for example.

As shown in FIG. 18, process 1800 may include operations 1810 and 1820. In an example, operation 1810 includes transmitting by a first STA, to a second STA, a first frame indicating a capability of the first STA to receive a number of repetitions of a first signal field of a PPDU. In an example, the number of repetitions is more than two. The first STA may be a UHR non-AP STA while the second STA may be a UHR AP to which the UHR non-AP STA is associated with. Likewise, the first STA may be a UHR AP while the second STA may be a non-AP STA associated with the UHR AP.

In an example, the first signal field may include a first universal signal symbol (U-SIG 1) and a second universal signal symbol (U-SIG 2) both having a same number of repetitions. In an embodiment, the encoding of a first copy of the U-SIG 1 may be based on a first modulation scheme and the subsequent copies may be based on a second modulation scheme different from the first modulation scheme. For example, the first modulation scheme uses BPSK modulation while the second modulation scheme uses QBPSK modulation.

In an example, the PPDU may include a second signal field, the second signal field may be encoded with the same number of repetitions as the first signal field. For example, the second signal field may have the same number of repetitions as the repetitions of U-SIG 1 or U-SIG 2. The second signal field may include at least one UHR signal field.

In an example, the first frame may include a first maximum number of time domain repetitions for the first signal field that the first STA can receive.

In an example, process 1800 further includes transmitting by the first STA, to the second STA, a frame indicating a capability of the first STA to receive two or more repetitions in the frequency domain of the first signal field. This frame can be the first frame or a second frame different from the first frame. In an example, the first frame or the second frame further indicates a maximum number of frequency domain repetitions for the first signal field that the first STA can receive.

In an example, the first STA may be a non-AP STA while the second STA is an AP. In this example, the first frame may be an association response or an authentication response. Further, the first STA may receive a frame from the second STA indicating a second maximum number of time domain repetitions to be used by the first STA.

As shown in FIG. 18, operation 1820 includes receiving, by the first STA, a PPDU wherein the first signal field comprises up to the number of repetitions based on the capability indicated in the first frame. In an example, process 1800 further includes transmitting, by the first STA, to the second STA, a repetition feedback indicating a suggested number of repetitions of the first signal field for a subsequent PPDU transmission.

What is claimed is:

1. A first station (STA) comprising:
one or more processors; and
memory storing instructions that, when executed by the one or more processors, cause the first STA to:
receive a first frame indicating a capability of a second STA to receive a first number of repetitions of a first signal field of a Physical Layer Protocol Data Unit (PPDU), wherein the first number of repetitions comprises more than two;
encode the PPDU such that the first signal field comprises up to the first number of repetitions based on the capability of the second STA; and
transmit, to the second STA, the PPDU, based on the encoding.

2. The first STA of claim 1, wherein the first signal field comprises a first universal signal symbol and a second universal signal symbol.

3. The first STA of claim 2, wherein the encoding of the PPDU comprises encoding:
a first copy of the first universal signal symbol based on a first modulation scheme; and
one or more subsequent copies of the first universal signal symbol based on a second modulation scheme, different from the first modulation scheme.

4. The first STA of claim 3, wherein the first modulation scheme comprises binary phase-shift keying (BPSK) and the second modulation scheme comprises quadrature BPSK (QBPSK).

5. The first STA of claim 1, wherein the PPDU comprises a second signal field, the second signal field being encoded with a same number of repetitions as the first number of repetitions of the first signal field.

6. The first STA of claim 5, wherein the second signal field comprises at least one ultra-high reliability (UHR) signal field (UHR-SIG).

7. The first STA of claim 1, wherein the first number of repetitions comprises a maximum number of time domain repetitions for the first signal field that the second STA is able to receive.

8. The first STA of claim 1, wherein the instructions, when executed by the one or more processors, further cause the first STA to receive, from the second STA, a second frame indicating a capability of the second STA to receive a second number of repetitions, in frequency, of the first signal field.

9. The first STA of claim 8, wherein the first signal field is repeated, in frequency, based on the second number of repetitions.

10. A first station (STA) comprising:
one or more processors; and
memory storing instructions that, when executed by the one or more processors, cause the first STA to:
transmit, to a second STA, a first frame indicating a capability of the first STA to receive a first number of repetitions of a first signal field of a Physical Layer Protocol Data Unit (PPDU); and
receive the PPDU, wherein the first signal field comprises up to the first number of repetitions based on the capability.

11. The first STA of claim 10, wherein the first signal field comprises a first universal signal symbol and a second universal signal symbol.

12. The first STA of claim 11, wherein a first copy of the first universal signal symbol is based on a first modulation scheme, and wherein one or more subsequent copies of the first universal signal symbol are based on a second modulation scheme, different from the first modulation scheme.

13. The first STA of claim 12, wherein the first modulation scheme comprises binary phase-shift keying (BPSK) and the second modulation scheme comprises quadrature BPSK (QBPSK).

14. The first STA of claim 10, wherein the PPDU comprises a second signal field, the second signal field being encoded with a same number of repetitions as the first number of repetitions of the first signal field.

15. The first STA of claim 14, wherein the second signal field comprises at least one ultra-high reliability (UHR) signal field (UHR-SIG).

16. The first STA of claim 10, wherein the first number of repetitions is a maximum number of time domain repetitions for the first signal field that the first STA is able to receive.

17. The first STA of claim 10, further comprising transmitting, by the first STA to the second STA, a second frame indicating a capability of the first STA to receive a second number of repetitions in a first frequency domain of the first signal field.

18. The first STA of claim 17, wherein the first signal field is repeated, in frequency, based on the second number of repetitions.

19. A non-transitory computer-readable medium comprising instructions that, when executed by one or more processors, cause a first station (STA) to:
receive a first frame indicating a capability of a second STA to receive a first number of repetitions of a first signal field of a Physical Layer Protocol Data Unit (PPDU), wherein the first number of repetitions is more than two;
encode the PPDU such that the first signal field comprises up to the first number of repetitions, based on the capability of the second STA; and
transmit, to the second STA, the PPDU, based on the encoding.

20. The non-transitory computer-readable medium of claim 19, wherein the first signal field comprises a first universal signal symbol and second universal signal symbol.
